(19) United States
(12) Patent Application Publication
(10) Pub. No.: US 2026/0225436 A1
(43) Pub. Date: Aug. 6, 2026

(54) TORQUE ROD

(71) Applicant: TOYOTA JIDOSHA KABUSHIKI KAISHA, Toyota-shi (JP)

(72) Inventor: Toshiya TAKAHASHI, Miyoshi-shi (JP)

(73) Assignee: TOYOTA JIDOSHA KABUSHIKI KAISHA, Toyota-shi (JP)

(21) Appl. No.: 19/346,815

(22) Filed: Oct. 1, 2025

(30) Foreign Application Priority Data
Jan. 31, 2025 (JP) 2025-015160

(51) Int. Cl. B60K 1/00

(52) U.S. Cl. CPC B60K 1/00; B60K 2001/001

(57) ABSTRACT

A first metal fitting having a first body portion connected to the suspension member and a first leg portion extending from the first body portion, and a second metal fitting having a second body portion connected to the transaxle and a second leg portion which extends from the second body portion and is fastened to the first leg portion by a fastener having an axial direction in the vehicle width direction, the first leg portion is a torque rod provided, the first leg portion is formed narrower toward the second leg portion from the first body portion in a side view, and is formed in a shape having a wide portion wider in a plan view.

### CROSS-REFERENCE TO RELATED APPLICATION

This application claims priority to Japanese Patent Application No. 2025-015160 filed on January 31, 2025. The disclosure of the above-identified application, including the specification, drawings, and claims, is incorporated by reference herein in its entirety.

### BACKGROUND

### Technical Field

The present disclosure relates to a torque rod.

### Description of Related Art

There has hitherto been known a structure including a mount portion that supports a power unit on a vehicle body, a torque rod that is interposed between the power unit and the vehicle body and restricts rolling of the power unit due to a driving reaction force within a predetermined range, and a coupling portion provided on the torque rod and coupled to a support shaft on the vehicle body side via an insulator (see Japanese Unexamined Patent Application Publication No. 2006-327458 (JP 2006-327458 A), for example).

### SUMMARY

The coupling portion of the torque rod is coupled by a bolt, the axial direction of which corresponds to the vehicle width direction, and the rigidity of the coupling portion is reduced (the deformation resistance is reduced) by reducing the dimension in the up-down direction in a side view when viewed from the vehicle width direction. As a result, the coupling portion of the torque rod receives the load of the driving reaction force from the transaxle (power unit). At the time of a front collision of the vehicle, the coupling portion of the torque rod is broken by the load input from the vehicle front side to secure the energy absorbing stroke.

However, in such a configuration, the coupling portion of the torque rod is also easily broken by a load from the vehicle width direction outer side generated at the time of an offset collision or an oblique collision of the vehicle. In order to realize a lightweight skeleton member without increasing the load bearing capacity of a member extending in the front-rear direction of a side member or a suspension member, it is preferable that the coupling portion of the torque rod is not broken by a load input from the vehicle width direction outer side. However, when the dimension of the coupling portion of the torque rod in the up-down direction is increased, it is difficult to receive the load of the driving reaction force from the transaxle.

Therefore, an object of the present disclosure is to obtain a torque rod capable of effectively receiving a load of a driving reaction force from a transaxle by reducing the rigidity with respect to a load input from the vehicle front side, and improving the rigidity with respect to a load input from the vehicle width direction outer side.

In order to achieve the above object, a first aspect of the present disclosure provides a torque rod including: a first metal fitting including a first body portion connected to a suspension member and a first leg portion extending from the first body portion; and a second metal fitting including a second body portion connected to a transaxle and a second leg portion extending from the second body portion and fastened to the first leg portion by a fastener, an axial direction of which corresponds to a vehicle width direction, in which the first leg portion is shaped to be narrow from the first body portion toward the second leg portion in a side view, and is shaped to include a wide portion that is wide in a plan view.

According to the disclosure of the first aspect, the first metal fitting includes a first body portion connected to the suspension member and a first leg portion extending from the first body portion, and the second metal fitting includes a second body portion connected to the transaxle and a second leg portion extending from the second body portion and fastened to the first leg portion by the fastener, the axial direction of which corresponds to the vehicle width direction.

Here, the first leg portion is shaped to be narrow from the first body portion toward the second leg portion in a side view. Therefore, the coupling portion between the first leg portion and the second leg portion has reduced rigidity with respect to the load input from the vehicle front side, and can effectively receive the load of the driving reaction force from the transaxle. In addition, the first leg portion is shaped to include a wide portion that is wide in a plan view. Therefore, the rigidity of the first leg portion with respect to the load input from the vehicle width direction outer side is improved.

A second aspect of the present disclosure provides the torque rod according to the first aspect, in which: the first leg portion is shaped to be bifurcated so as to interpose the second leg portion from vehicle width direction outer sides; and the wide portion is provided on a side of the second leg portion.

According to the disclosure of the second aspect, the first leg portion is shaped to be bifurcated so as to interpose the second leg portion from the vehicle width direction outer sides, and the wide portion is provided on the side of the second leg portion. Therefore, the rigidity with respect to the load input from the vehicle width direction outer side is improved, particularly at the coupling portion between the first leg portion and the second leg portion.

As described above, according to the present disclosure, it is possible to effectively receive a load of a driving reaction force from a transaxle by being able to reduce the rigidity with respect to a load input from the vehicle front side, and improve the rigidity with respect to a load input from the vehicle width direction outer side.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view showing a torque rod according to the present embodiment together with a suspension member and the like;

FIG. 2 is a schematic plan view showing a torque rod according to the present embodiment;

FIG. 3 is a schematic side view showing a torque rod according to the present embodiment;

FIG. 4A is a schematic plan view of a torque rod according to a comparative embodiment; and

FIG. 4B is a schematic side view showing a torque rod according to a comparative embodiment.

### DETAILED DESCRIPTION OF EMBODIMENTS

Hereinafter, an embodiment according to the present disclosure will be described in detail with reference to the drawings. For convenience of description, the arrow UP, the arrow FR, and the arrow RH appropriately shown in the figures indicate the upward direction of a vehicle, the forward direction of the vehicle, and the right direction of the vehicle, respectively. In addition, in the following description, when the vertical, front-rear, and left-right directions are described without special mention, the vertical, front-rear, and left-right directions of the vehicle are assumed to be indicated. Further, the right-left direction is synonymous with a vehicle width direction.

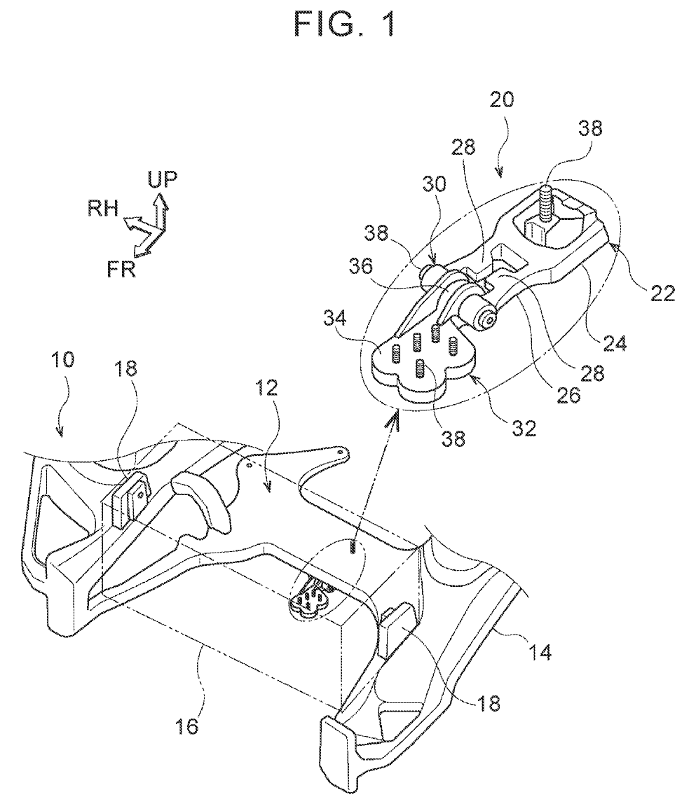

As shown in FIG. 1, a vehicle 10 such as a battery electric vehicle in which a torque rod 20 according to the present embodiment is provided has a suspension member 12. A wheel house 14 having a symmetrical shape capable of accommodating left and right front wheels (not shown) is provided on both left and right sides of the suspension member 12.

A transaxle 16 having a motor or the like for driving the left and right front wheels is provided on the front side of the suspension member 12. Therefore, a pair of left and right mount portions 18 for supporting the transaxle 16 is provided on the vehicle width direction inner side of the wheel house 14.

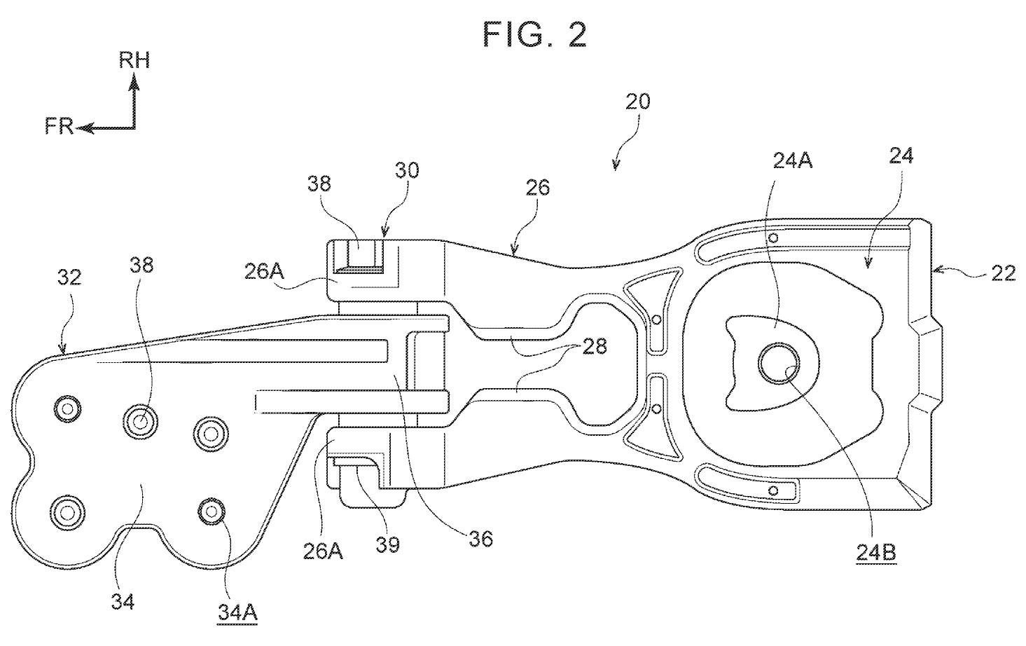

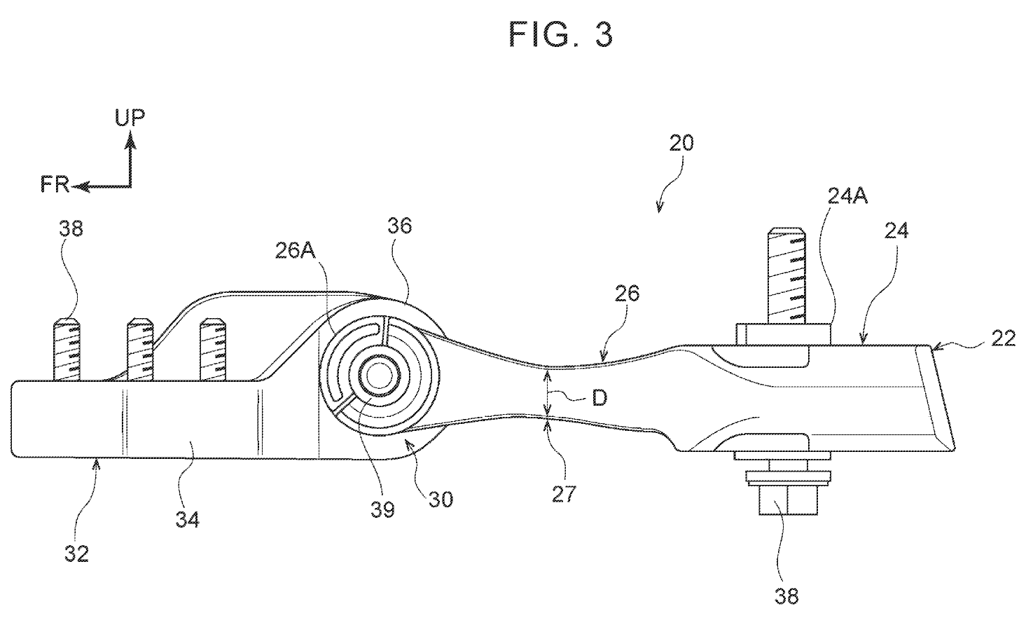

The torque rod 20 according to the present embodiment is installed between the suspension member 12 and the transaxle 16. Specifically, as shown in FIGS. 2 and 3, the torque rod 20 includes a first metal fitting 22 having a first body portion 24 connected to a fastened portion (not shown) formed at a substantially central portion in the vehicle width direction on the lower surface of the suspension member 12, and a first leg portion 26 integrally extending from the first body portion 24 toward the front side.

The torque rod 20 includes a second metal fitting 32 having a second body portion 34 connected to a fastened portion (not shown) formed at a substantially central portion in the vehicle width direction on the lower surface of the transaxle 16, and a second leg portion 36 integrally extending rearward from the second body portion 34. The second leg portion 36 is fastened to the first leg portion 26 by a bolt 38 as a fastener whose axial direction is the vehicle width direction.

That is, the first leg portion 26 is formed in a bifurcated shape in which the second leg portion 36 is sandwiched from the vehicle width direction outer side, and a cylindrical portion 26A having the vehicle width direction as the axial direction is formed at the respective distal end portions. The second leg portion 36 is formed in a cylindrical shape having an axial direction in the vehicle width direction, and a rubber bush (not shown) is provided on the inner peripheral surface side of the through hole.

Then, the through hole of each cylindrical portion 26A and the through hole of the second leg portion 36 in the first leg portion 26 are communicated with each other, the bolt 38 is inserted into each through hole and is screwed into the nut 39, so that the first leg portion 26 and the second leg portion 36 are rotatably connected. In the following description, a coupling portion between the first leg portion 26 and the second leg portion 36 is referred to as a coupling portion 30.

Further, the first leg portion 26 is formed so as to gradually narrow from the first body portion 24 toward the second leg portion 36 in a side view when viewed from the vehicle width direction (so as to reduce the dimension in the up-down direction), and has a substantially constricted shape having a narrow portion 27 that becomes the narrowest width D (see FIG. 3). The first leg portion 26 is formed in a shape having a wide portion 28 that is wide in plan view (see FIG. 2).

That is, the first leg portion 26 is formed in a wide shape (a shape in which the dimension in the vehicle width direction is increased) in which the region on the side of the second leg portion 36 (the region on 26A side of the cylindrical portion including the narrow portion 27) protrudes in the vehicle width direction from the region on the side of the first body portion 24 in plan view. As a result, the rigidity of the first leg portion 26 with respect to the vehicle width direction in the region on the second leg portion 36 side is improved.

The first body portion 24 has a substantially cylindrical fastening portion 24A at a central portion thereof, and a substantially cylindrical rubber bush (not shown) is fitted to the fastening portion 24A. The bolt 38 is inserted into the through hole 24B of the fastening portion 24A from the lower side and is fastened to the fastened portion on the lower surface of the suspension member 12, so that the first body portion 24 is attached to the suspension member 12.

The second body portion 34 is formed in a substantially flat plate shape having a predetermined size and thickness, and has a through hole 34A having a circular shape in plan view at a plurality of predetermined positions. The second body portion 34 is attached to the transaxle 16 by being fastened to the fastened portion on the lower surface of the transaxle 16 by inserting the bolts 38 from below into the through holes 34A.

Next, the operation of the torque rod 20 according to the present embodiment configured as described above will be described.

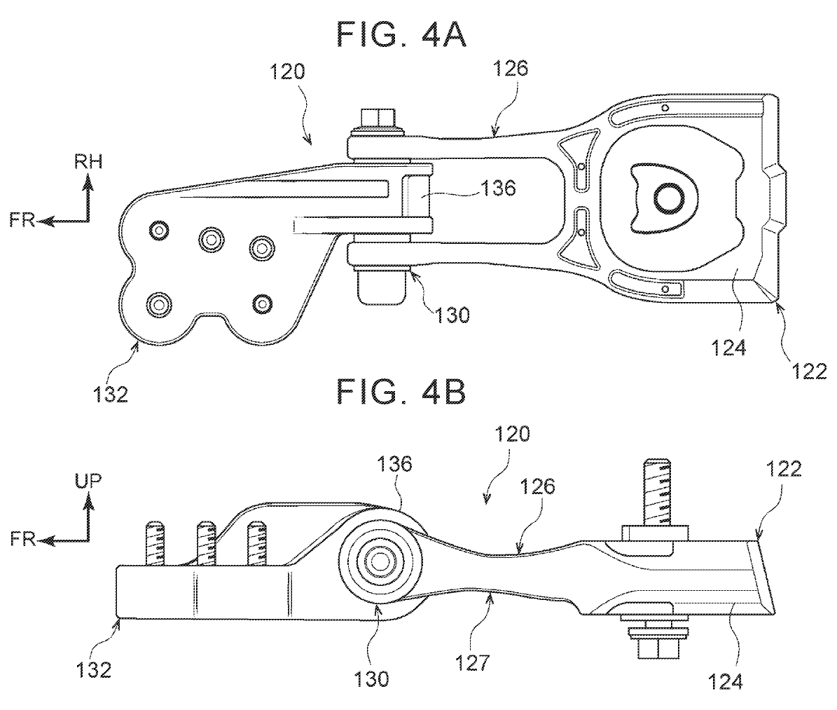

First, a comparative example shown in FIGS. 4A and 4B will be described. As shown in FIG. 4B, the first leg portion 126 of the first metal fitting 122 of the torque rod 120 according to this comparative example is formed so as to gradually narrow from the first body portion 124 of the first metal fitting 122 toward the second leg portion 136 of the second metal fitting 132 in a side view, and has a substantially constricted shape having a narrow portion 127 which is the narrowest width.

Therefore, the coupling portion 130 (the first leg portion 126) of the torque rod 120 according to this comparative example can reduce the rigidity with respect to the load input from the front side, and can receive the load of the driving reaction force from the transaxle 16. Then, the coupling portion 130 (the first leg portion 126) of the torque rod 120 according to this comparative example can be broken (urged to break) by the load input from the front side of the vehicle 10 at the time of a front collision of the vehicle, and an energy absorbing stroke can be secured.

However, as shown in FIG. 4A, the first leg portion 126 of the first metal fitting 122 of the torque rod 120 according to the comparative example is not formed with a wide portion, and the axial length of the first leg portion 126 of the coupling portion 130 is not formed with a long length. Therefore, the coupling portion 130 (the first leg portion 126) of the torque rod 120 is easily broken by a load input from the outside in the vehicle width direction which is generated at the time of an offset collision or an oblique collision of the vehicle 10.

On the other hand, as shown in FIGS. 1 to 3, in the torque rod 20 according to the present embodiment, the first leg portion 26 of the first metal fitting 22 is formed so as to gradually narrow from the first body portion 24 of the first metal fitting 22 toward the second leg portion 36 of the second metal fitting 32 in a side view, and has a substantially constricted shape having a narrow portion 27 having the narrowest width D.

Therefore, the coupling portion 30 (the first leg portion 26) of the torque rod 20 according to the present embodiment can reduce the rigidity with respect to the load input from the front side, and can effectively receive the load of the driving reaction force from the transaxle 16. The coupling portion 30 (the first leg portion 26) of the torque rod 20 according to the present embodiment can be broken (urged to break) by a load input from the front side thereof when the vehicle 10 collides with the front surface, and thus an energy absorbing stroke can be secured.

Here, in the torque rod 20 according to the present embodiment, the first leg portion 26 of the first metal fitting 22 is formed in a shape having a wide portion 28 that is wider in a plan view. Specifically, the first leg portion 26 is formed such that, in a plan view, a region on the second leg portion 36 side (a region on the cylindrical portion 26A side including the narrow portion 27) is wider than a region on the first body portion 24 side in the vehicle width direction.

Therefore, in the coupling portion 30 (the first leg portion 26) of the torque rod 20, it is possible to improve the rigidity with respect to the load input from the outside in the vehicle width direction which is generated at the time of the offset collision or the oblique collision of the vehicle 10, and it is possible to suppress the coupling portion 30 (the first leg portion 26) of the torque rod 20 being broken due to the load input from the outside in the vehicle width direction.

In particular, in the torque rod 20 according to the present embodiment, the first leg portion 26 is formed in a bifurcated shape sandwiching the second leg portion 36 from the outside in the vehicle width direction, and the wide portion 28 is formed on the second leg portion 36 side. Therefore, in the coupling portion 30 (the first leg portion 26) of the torque rod 20, it is possible to more effectively improve the rigidity with respect to the load input from the outside in the vehicle width direction.

As described above, in the coupling portion 30 (the first leg portion 26) of the torque rod 20, when the rigidity with respect to the load inputted from the outside in the vehicle width direction can be improved, in the vehicle 10 such as a battery electric vehicle, the weight-reduced skeleton member can be realized without increasing the load bearing capacity of the side member (not shown) or the member extending in the front-rear direction of the suspension member 12.

As described above, the torque rod 20 according to the present embodiment has been described on the basis of the drawings, but the torque rod 20 according to the present embodiment is not limited to the illustrated one, and can be appropriately changed in design without departing from the gist of the present disclosure. For example, the number of through holes 34A formed in the second body portion 34 of the second metal fitting 32 is not limited to the illustrated number (five), and can be appropriately changed according to the configuration of the second body portion 34.

What is claimed is:

1. A torque rod comprising:
a first metal fitting including a first body portion connected to a suspension member and a first leg portion extending from the first body portion; and
a second metal fitting including a second body portion connected to a transaxle and a second leg portion extending from the second body portion and fastened to the first leg portion by a fastener, an axial direction of which corresponds to a vehicle width direction, wherein
the first leg portion is shaped to be narrow from the first body portion toward the second leg portion in a side view, and is shaped to include a wide portion that is wide in a plan view.

2. The torque rod according to claim 1, wherein:
the first leg portion is shaped to be bifurcated so as to interpose the second leg portion from vehicle width direction outer sides; and
the wide portion is provided on a side of the second leg portion.
